(19) United States
(12) Patent Application Publication
(10) Pub. No.: US 2003/0202084 A1
(43) Pub. Date: Oct. 30, 2003

(54) Image forming apparatus and method of controlling light beam

(75) Inventor: Tatsuya Funakoshi, Yokohama-shi (JP)

Correspondence Address: FOLEY AND LARDNER, SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/424,731

(22) Filed: Apr. 29, 2003

(30) Foreign Application Priority Data
Apr. 30, 2002 (JP) 2002-128878

(51) Int. Cl. G03G 15/00; B41J 2/47

(52) U.S. Cl. 347/129; 347/234

(57) ABSTRACT

When power is turned on in an apparatus, respective units and devices in the apparatus such as a heat roller of a fixing device are initialized and a scanning position control is performed by which positional errors in a main scanning direction and in a sub-scanning direction of a plurality of light beams are converged to respective predetermined values or less, and the apparatus is brought into a standby state. In this standby state, a control between sheets is performed every several seconds, for example. The control between sheets means a control of changing a beam position, for example, in the sub-scanning direction by a minimum amount of adjustment, if necessary. In this manner, the beam position in the sub-scanning direction is always controlled at an optimum position and when a copy start button is pressed down, a copying operation can be immediately started.

### CROSS-REFERENCE TO RELATED APPLICATIONS

This application is based upon and claims the benefit of priority from the prior Japanese Patent Application No. 2002-128878, filed Apr. 30, 2002, the entire contents of which are incorporated herein by reference.

### BACKGROUND OF THE INVENTION

1. Field of the Invention

The present invention relates to an image forming apparatus such as a digital copying machine in which a photosensitive drum is simultaneously scanned with and exposed to a plurality of laser beams at the time of copying to form an electrostatic latent image on the photosensitive drum.

2. Description of the Related Art

In recent years, various kinds of digital copying machines have been developed in which an image is formed, for example, by use of an operation of scanning with and exposing to a laser beam and an electrophotographic process.

Then, in order to further increase an image forming speed, a digital copying machine has been recently developed in which a plurality of laser beams are generated (that is, multi-beam type) and the simultaneous scanning of a plurality of lines are performed by use of the plurality of laser beams.

Such a multi-beam type digital copying machine has a lens system unit mainly constructed of a plurality of semiconductor laser oscillators that each generate a laser beam, Garvano mirrors that each control a position in a sub-scanning direction of the laser beam outputted from each of the plurality of laser oscillators, a polygon mirror that further reflects each laser beam, reflected by the Garvano mirror, toward a photosensitive drum and scans the photosensitive drum with each laser beam, a collimate lens, and an f-θ lens.

In order to form an image at a correct position on a sheet, the exposure positions of the laser beams in a main scanning direction and in a sub-scanning direction need to be correctly adjusted. In general, the adjustment of a beam scanning position is performed at the time when power is turned on and the units and devices of the apparatus are initialized, that is, at the time of the so-called warming-up, at a standby time when the warming-up is finished and the apparatus is in a state of readiness for a copying operation, and just before a copy start button is pressed down to start the copying operation.

As described above, in the multi-beam type digital copying machine, a beam position in the sub-scanning direction and a beam exposure position in the main scanning position are controlled for each laser beam so that the positional errors fall in a few micron meters or less. The adjustment of the beam position in the sub-scanning direction is performed by a control in which the Garvano mirror is given a direction value until the error becomes not higher than tolerance to change the sub-scanning position of the laser beam. The adjustment of the beam exposure position in the main scanning direction is performed by use of a pixel clock generating circuit and a delay circuit that delays a pixel clock by a unit of a few fractions of one pixel exposure time. Generally, the adjustment of the beam scanning position in the multi-beam type digital copying machine needs a comparatively long processing time, so that it has been desired to shorten this adjustment processing time.

### BRIEF SUMMARY OF THE INVENTION

Therefore, an object of the present invention is to shorten a time required to adjust a beam position and to improve the total copying capacity of an apparatus.

When power is turned on in an apparatus, respective units and devices of the apparatus such as a heat roller of a fixing device and a photosensitive drum are initialized, a control of a beam scanning position is performed by which positional errors in a main scanning direction and in a sub-scanning direction of a plurality of light beams are converged to predetermined values or less, and the apparatus is brought into a standby state. Thereafter, a beam control according to the state of the apparatus is performed.

In one embodiment, in the standby state, a simplified control of the beam scanning position is performed every predetermined time. This simplified control of the beam scanning position means, for example, a control of changing a beam position in the sub-scanning direction by a minimum amount of adjustment, if necessary. Moreover, in another embodiment, during a copying operation, the foregoing simplified control of the beam scanning position is performed every a predetermined number of copies.

### BRIEF DESCRIPTION OF THE SEVERAL VIEWS OF THE DRAWING

FIG. 1 is a block diagram showing a configuration of a digital copying machine according to one embodiment of the present invention.

FIG. 2 is an illustration showing a configuration of an optical system unit and a positional relationship between the optical system unit and a photosensitive drum.

FIG. 3 is a block diagram showing a configuration of a control system the main part of which is a control of a multi-beam optical system.

FIG. 4 is a flow chart showing a control operation related to a printing unit.

FIG. 5 is an illustration that schematically shows a configuration of an light beam detecting device and a relationship between the light beam detecting device and an light beam scanning.

FIG. 6 is an illustration showing a state where a region between sensor patterns S1 and S2 on the light beam detecting device is irradiated with beams of five pixel clocks.

FIG. 7 is a flow chart showing a control between sheets operation.

FIG. 8 is a flow chart showing another example of the control between sheets operation.

### DETAILED DESCRIPTION OF THE INVENTION

A preferred embodiment of the present invention will be described in detail with reference to the drawings. The following description is given for the embodiment of this invention and does not limit an apparatus and method of this invention.

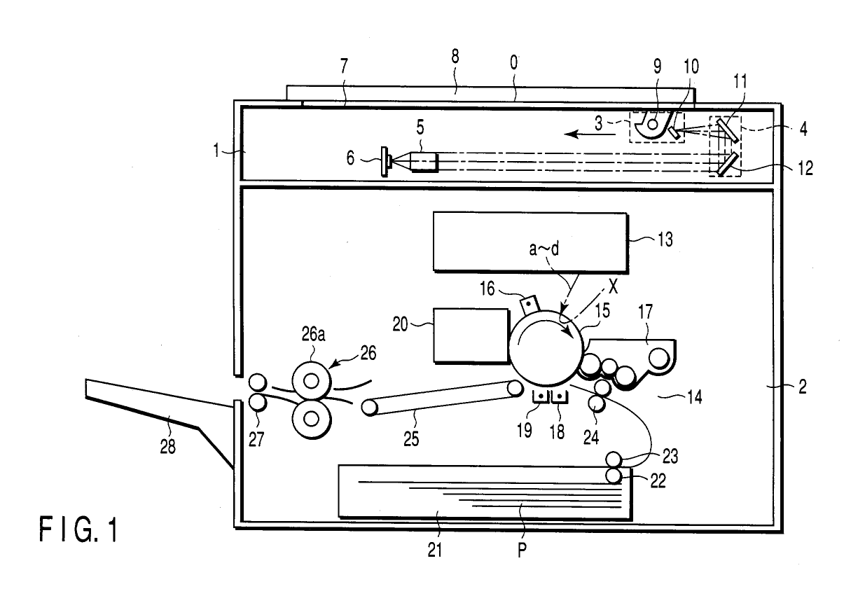

FIG. 1 is a block diagram showing a configuration of a digital copying machine as an image forming apparatus according to one embodiment of the invention. This digital copying machine includes a scanner unit 1 as image reading means and a printer unit 2 as image forming means. The scanner unit 1 is constructed of a first carriage 3 and a second carriage 4, which can move in the direction shown by arrow, an image forming lens 5, and an photoelectric conversion device 6 and the like.

In FIG. 1, an original document O is placed face down on a document stage 7 made of a transparent glass. The original document O is pressed onto the document stage 7 with an original document fixing cover 8 provided such that it can be freely opened or closed.

The original document O is irradiated with a light source 9 and light reflected by the original document O is focused on a light receiving surface of the photoelectric conversion device 6 via mirrors 10, 11, 12 and the image forming lens 5. Here, the first carriage 3 mounted with the above-mentioned light source 9 and mirror 10 and the second carriage 4 mounted with the mirrors 11, 12 are moved at a relative speed of 2:1 so as to make an optical path length constant. The first carriage 3 and the second carriage 4 are moved synchronously with a reading timing signal from the right to the left by a carriage driving motor (not shown).

As described above, an image of the original document O placed on the document stage 7 is read sequentially one line by one line by the scanner unit 1 and reading output is converted into a digital image signal of 8 bits showing the light and shade of the image by the image processing unit (not shown).

The printer unit 2 is constructed of an optical system unit 13 and an image forming section 14 in which an electrophotographic process capable of forming an image is combined with a sheet P of a medium on which the image is to be formed. That is, the image signal read from the original document O by the scanner unit 1 is processed by the image processing section (not shown) and then transformed into a laser beam (hereinafter referred to as an light beam) from a semiconductor laser oscillator. Here, in the present embodiment, a multi-beam optical system using a plurality of (two or more) semiconductor laser oscillators is employed.

The configuration of the optical system unit 13 will be later described in detail, and the plurality of semiconductor laser oscillators provided in the unit emit light according to laser modulated signal outputted from the image forming section (not shown) and a plurality of light beams emitted thereby are reflected by polygon mirrors to be made scanning light beams, thereby being outputted outside the unit.

The plurality of light beams outputted from the optical system unit 13 are focused, as a spot of scanning light having requisite resolution, on a point at an exposure position X on a photosensitive drum 15 as an image supporting body, whereby the photosensitive drum 15 is scanned with and exposed to the light beams. In this manner, an electrostatic latent image according to the image signal is formed on the photosensitive drum 15.

Around the photosensitive drum 15 are arranged an electrostatic charger 16 for charging the surface thereof, a developing device 17, a transfer charger 18, a separation charger 19, a cleaner 20 and the like. The photosensitive drum 15 is rotated at a predetermined peripheral speed by a driving motor (not shown) and charged by the electrostatic charger 16 opposed to the surface thereof. The plurality of light beams are focused as spots on the point at the exposure position X on the charged photosensitive drum 15.

The electrostatic latent image formed on the photosensitive drum 15 is developed by toner (developing agent) from the developing device 17. A toner image formed on the photosensitive drum 15 by development is transferred to a sheet P, which is fed to a transfer position at a proper timing by a paper feed system, by the transfer charger 18.

In a paper feed system, the sheets P in a paper feed cassette provided in the bottom thereof are separated and fed one by one by a paper feed roller 22 and a separating roller 23. Then, the sheet P is transported to a register roller 24 and fed to the transfer position at a predetermined timing. A paper transport mechanism 25, a fixing device 26, a paper discharge roller 27 for discharging the sheet P having the image formed thereon are arranged on the downstream side of the transfer charger 18. In this manner, the sheet P to which the toner image is transferred has the toner image fixed by the fixing device 26, passed over the discharge roller 27 and then discharged to an outside paper discharge tray 28.

Further, the photosensitive drum 15 that has finished transferring the toner image to the sheet P has toner remaining on the surface thereof removed by the cleaner 20 and is returned to an initial state to be brought into a standby state in which the next image forming operation is waited.

The image forming operation is continuously performed by repeating the above processing operations.

As described above, the original document O placed on the document stage 7 is read by the scanner unit 1 and the read information is subjected to a series of processings in the printer unit 2 and then recorded as the toner image on the sheet P.

Next, the optical system unit 13 will be described.

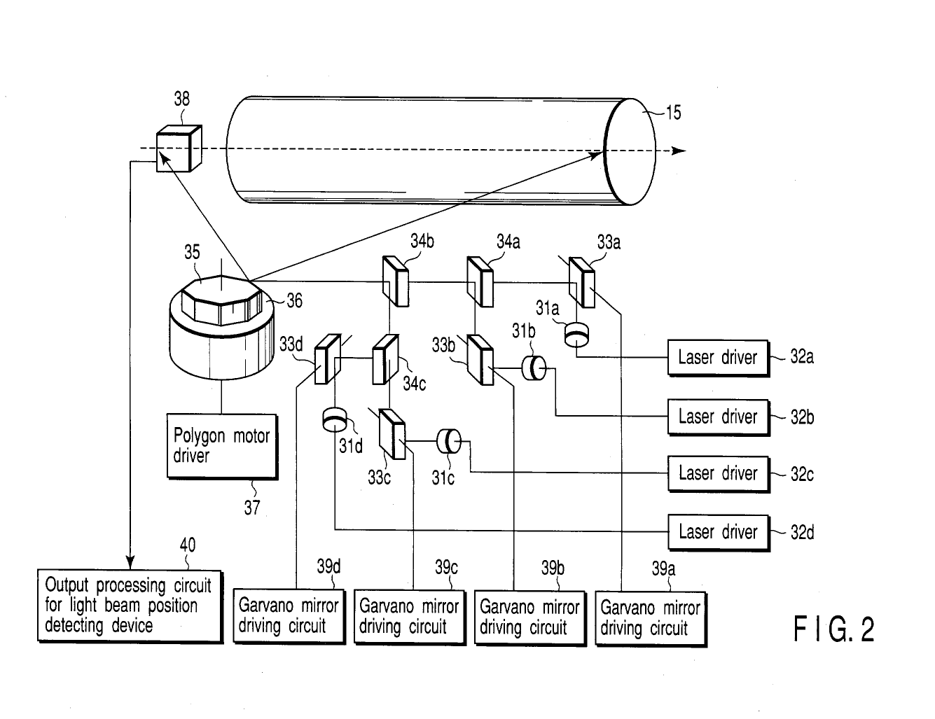

FIG. 2 shows the configuration of the optical system unit 13 and a positional relationship between the optical system unit 13 and the photosensitive drum 15. The optical system unit 13 has, for example, semiconductor laser oscillators 31a, 31b, 31c, and 31d as four light beam generating means built therein. The respective laser oscillators 31a to 31d form the image by one scanning line at the same time. This makes it possible to form the image at high speed without extremely increasing the number of revolutions of a polygon mirror.

That is, the laser oscillator 31a is driven by a laser driver 32a and an light beam outputted therefrom passes through a collimate lens (not shown) and then enters a Garvano mirror 33a as optical path changing means. The light beam reflected by the Garvano mirror 33a passes through a half mirror 34a and a half mirror 34b and enters a polygon mirror 35 as a polygonal rotating mirror.

The polygon mirror 35 is rotated at a constant speed by a polygon mirror motor 36 driven by a polygon mirror motor driver 37. In this manner, light reflected by the polygon mirror 35 performs scanning in a predetermined direction at an angular velocity determined by the number of revolutions of the polygon mirror motor 36. An light beam reflected by the polygon mirror 35 passes through an f-θ lens (not shown) and scans the light receiving surface of an light beam detecting device 38 as light beam passage detecting means and light beam position detecting means and the photosensitive drum 15 at a predetermined speed by the f-θ characteristics of the f-θ lens.

The laser oscillator 31b is driven by a laser driver 32b and an light beam outputted thereby passes through a collimate lens (not shown) and then is reflected by a Garvano mirror 33b and further reflected by the half mirror 34a. The light reflected by the half mirror 34a passes through the half mirror 34b and enters the polygon mirror 35. The optical path after the polygon mirror 35, as is the case with the laser oscillator 31a, passes through the f-θ lens (not shown) and scans the light receiving surface of the light beam detecting device 38 and the photosensitive drum 15 at the predetermined speed.

The laser oscillator 31c is driven by a laser driver 32c and an light beam outputted thereby passes through a collimate lens (not shown) and then is reflected by a Garvano mirror 33c and further passes through a half mirror 34c and is reflected by the half mirror 34b and enters the polygon mirror 35. The optical path after the polygon mirror 35, as in the cases of the laser oscillators 31a and 31b, passes through the f-θ lens (not shown) and scans the light receiving surface of the light beam detecting device 38 and the photosensitive drum 15 at the predetermined speed.

The laser oscillator 31d is driven by a laser driver 32d and an light beam outputted thereby passes through a collimate lens (not shown) and then is reflected by a Garvano mirror 33d and further reflected by the half mirror 34c and reflected by the half mirror 34b and then enters the polygon mirror 35. The optical path after the polygon mirror 35, as in the cases of the laser oscillators 31a, 31b, and 31c, passes through the f-θ lens (not shown) and scans the light receiving surface of the light beam detecting device 38 and the photosensitive drum 15 at the predetermined speed.

In this respect, each of the laser drivers 32a to 32d has an automatic power control (APC) circuit built therein and always makes each of the laser oscillators 31a to 31d emit light at a light emitting power level set by a main control unit (CPU) 51, which will be described later.

In this manner, the respective light beams emitted by the separate laser oscillators 31a, 31b, 31c, and 31d are combined with each other by the half mirrors 34a, 34b, and 34c and four light beams advances toward the polygon mirror 35.

Thus, the four light beams can scan the photosensitive drum 15 at the same time and hence can record an image at a rate four times as fast as a conventional single beam in a case where the number of revolutions of the polygon mirror 35 is the same.

The Garvano mirrors 33a, 33b, 33c, and 33d are used for adjusting (controlling) the positional relationship between the light beams in a sub-scanning direction and Garvano mirror driving circuits 39a, 39b, 39c, and 39d are connected to them, respectively.

The light beam detecting device 38 is used for detecting the sub-scanning positions, passage timings, and powers of the above-mentioned four light beams and is disposed near the end of the photosensitive drum 15 such that its light receiving surface is equal to the surface of the photosensitive drum 15. The control of the Garvano mirrors 33a, 33b, 33c, and 33d corresponding to the respective light beams (control of image forming positions in the sub-scanning direction), the control of light emitting powers (intensities) of the laser oscillators 31a, 31b, 31c, and 31d, and the control of light emitting timings (control of image forming positions in the main scanning direction) are performed on the basis of the detection signal from the light beam detecting device 38 (their detailed descriptions will be given later). In order to produce a signal required to perform these controls, an output processing circuit 40 for the light beam detecting device is connected to the light beam detecting circuit 38.

Next, a control system will be described.

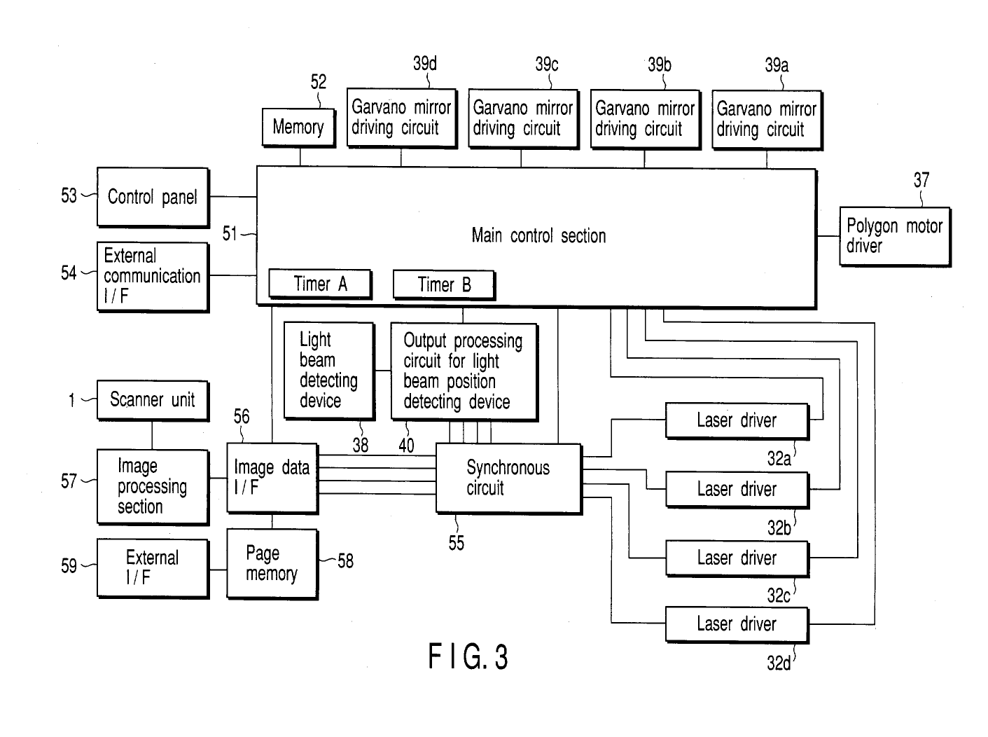

FIG. 3 mainly shows a control system that mainly controls a multi-beam optical system. That is, reference numeral 51 denotes a main control unit that performs a general control and is composed, for example, of a CPU. The main control unit controls, in a comprehensive manner, a memory 52, a control panel 53, an external communication interface (I/F) 54, the laser drivers 32a, 32b, 32c, and 32d, the polygon mirror motor driver 37, the Garvano mirror driving circuits 39a, 39b, 39c, and 39d, the output processing circuit 40 for light beam detecting device as signal processing means, a synchronous circuit 55, an image data interface (I/F) 56. Further, the main control unit 51 includes a timer A and a timer B for determining a start time of adjusting a beam position, which will be described later.

The image data I/F 56 is connected to the synchronous circuit 55 and an image processing section 57 and a page memory 58 are connected to the image data I/F 56. The scanner unit 1 is connected to the image processing section 57. An external interface (I/F) 59 is connected to the page memory 58.

Here, describing in brief the flow of image data when the image is formed, the flow is as follows.

First, in a case of the copying operation, as described above, the image of the original document O set on the document stage 7 is read by the scanner unit 1 and is sent to the image processing section 57. The image processing section 57 makes, for example, a well-known shading correction and a gamma correction, and performs various kinds of filtering processings, a gradation processing and the like to the image data from the scanner unit 1.

The image data from the image processing section 57 is sent to the image data I/F 56. The image data I/F 56 divides the image data among the four laser drivers 32a, 32b, 32c, and 32d.

The synchronous circuit 55 generates a clock synchronous with a timing when each light beam passes the light beam detecting device 38 and sends out the image data as a laser modulated signal from the image data I/F 56 to each of the laser drivers 32a, 32b, 32c, and 32d in synchronization with this clock.

In this manner, the image data is sent in synchronization with the scanning of each light beam, so that the image can be formed synchronously (at a correct position) in the main scanning direction.

The control panel 53 is a man-machine interface by which the copying operation is started or the number of sheets is set.

The present digital copying machine is constructed such that not only the copying operation is performed but also an image can be formed from the image data inputted from the outside via the external I/F 59 connected to the page memory 58. Here, the image date inputted from the external I/F 59 is stored once in the page memory 58 and then sent to the synchronous circuit 55 via the image data I/F 56.

Further, in a case where the present digital copying machine is controlled, for example, by the outside via a network, the external communication I/F 54 acts as the control panel 53.

The respective Garvano mirror driving circuits 39a, 39b, 39c, and 39d are circuits each of which drives each of the Garvano mirrors 33a, 33b, 33c, and 33d according to a value directed by the main control unit 51. Thus, the main control unit 51 can freely control the angle of each of the Garvano mirrors 33a, 33b, 33c, and 33d via each of the Garvano mirror driving circuits 39a, 39b, 39c, and 39d.

The polygon mirror motor driver 37 is a driver that drives the polygon mirror motor 36 for rotating the polygon mirror 35 scanning the four light beams described above. The main control unit 51 can start and stop rotating the polygon mirror motor driver 37 and change the number of revolutions thereof. The changing of the number of revolutions is performed when a recording pitch (resolution) is changed.

Each of the laser drivers 32a, 32b, 32c, and 32d has not only a function of making each of the laser oscillators 31a, 31b, 31c, and 31d emit light according to a laser modulated signal synchronous with the scanning of the light beam from the synchronous circuit 55 described above but also another function of forcibly separately making each of the laser oscillators 31a, 31b, 31c, and 31d emit light irrespective of the image data by a signal that is sent from the main control unit 51 and forcibly emits light.

The latter function is used to forcibly make the respective laser oscillators 31a, 31b, 31c, and 31d emit light when the control of a passing (scanning) position of the light beam and the control of an light beam power, which will be described later, are performed.

Further, the main control unit 51 sets the light emitting power of each of the laser oscillators 31a, 31b, 31c, and 31d to each of the laser drivers 32a, 32b, 32c, and 32d. The setting of the light emitting power is changed according to a change in process conditions and the detection of the sub-scanning position of the light beam.

The memory 52 stores information required for the control. For example, if the amount of control of each of the Garvano mirrors 33a, 33b, 33c, and 33d, circuit characteristics for detecting the sub-scanning position of the light beam (offset value of an amplifier) and printing area information corresponding to each light beam are stored, it is possible to bring the optical system unit 13 into a state capable of forming the image immediately after the power is started up.

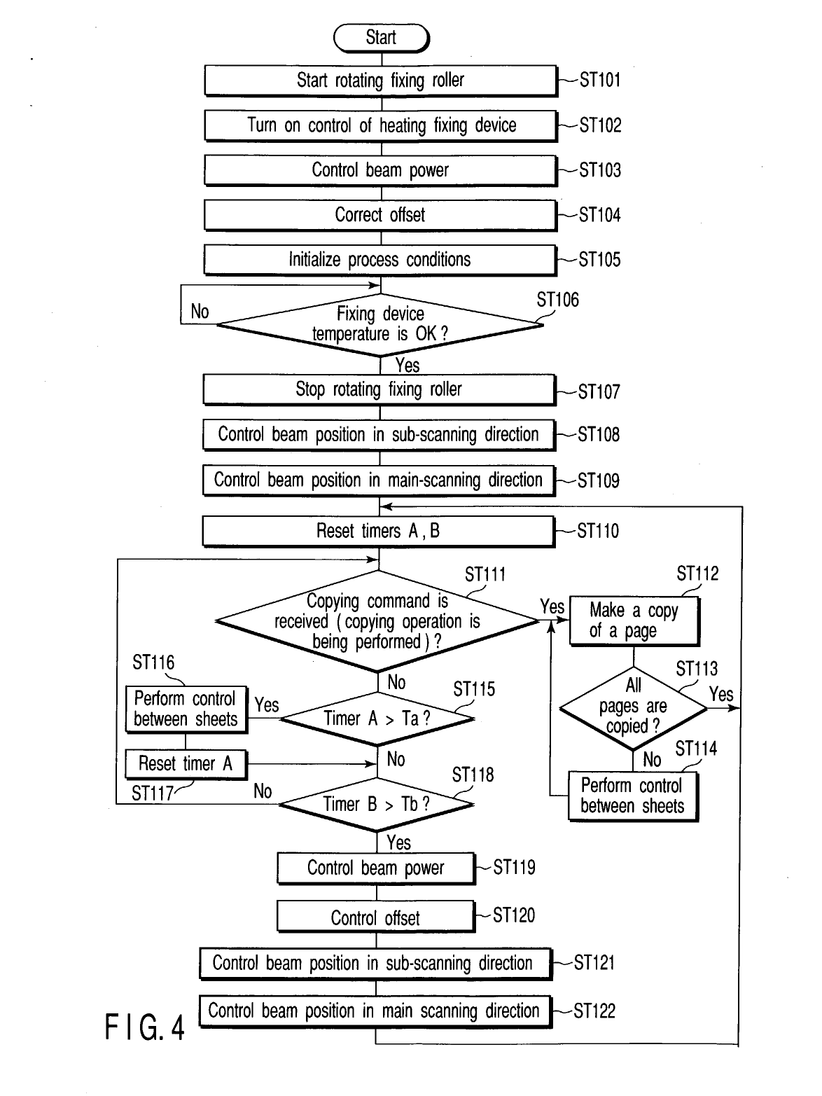

Next, a control operation relating to the printer unit 2 of the main control unit 51 will be described with reference to a flow chart shown in FIG. 4. Here, an operation relating to the scanner unit 1 will be omitted.

When the power of the present copying machine is turned on, the main control unit 51 rotates a heat roller 26a in a fixing device 26 and starts the heating control of the fixing device 26 (ST101, ST102) and continues rotating a fixing roller until the temperature of the fixing device 26 increases to a predetermined temperature.

The main control unit 51 executes an light beam power control routine, that is, controls the light beam powers so that the powers of the respective light beams become equal to each other on the photosensitive drum 15 (ST103). After the main control unit 51 controls the light beams, the main control unit 51 executes an offset correction routine, that is, detects an offset value of the output processing circuit 40 for the light beam detecting device and performs a correction processing (ST104).

Next, the main control unit 51 rotates the photosensitive drum 15 and initializes conditions relating to a process such as setting a condition for the surface potential of the photosensitive drum 15 at a predetermined value (ST105). This initialization operation includes the operation of the developing device 17 and the detection of a toner concentration. In a case where the toner concentration is beyond a predetermined range, the main control unit 51 informs the control panel 53 that the toner concentration is beyond the predetermined range to urge a user to replace the toner. When the temperature of the fixing device 26 increases to the predetermined temperature, in other words, when the initial setting of the fixing device 26 is completed, the fixing roller is stopped from rotating (ST106, ST107). As described above, the warming-up of the apparatus, accompanied by the initialization of the respective units and devices immediately after the turning-on of the power, is called “a pre-run”.

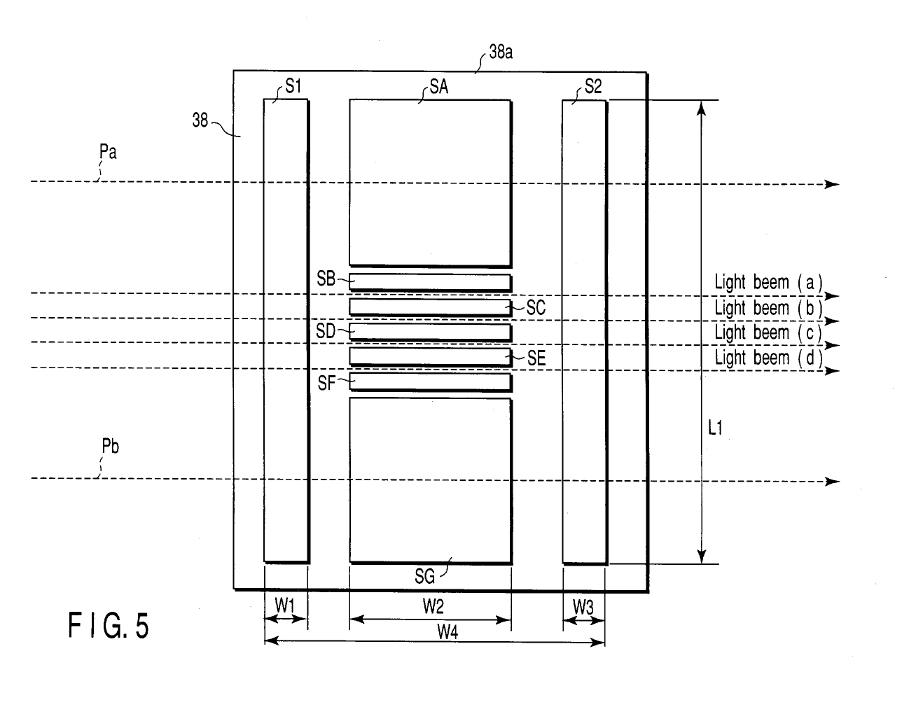

After the pre-run, the main control unit 51 executes a routine of control of a position in a sub-scanning direction of the light beam (ST108). FIG. 5 schematically shows the configuration of the light beam detecting device 38 and the relationship between the light beam detecting device 38 and the light beam scanning. The light beams (a) to (d) from the semiconductor laser oscillators 31a to 31d are swung from side to side by the rotation of the polygon mirror 35 to cross the light beam detecting device 38.

The light beam detecting device 38 is constructed of, for example, two sensor patterns S1, S2 that are long in a longitudinal direction, seven sensor patterns SA to SG arranged in such a way as to be sandwiched between this two sensor patterns S1, S2, and a holding board 38a as a holding member that integrally holds the respective sensor patterns S1, S2, and SA to SG. Here, the respective sensor patterns S1, S2, and SA to SG are constructed of, for example, photodiodes.

The sensor patterns S1, S2 are patterns that detect the start and end of passage of the light beams. The sensor patterns SA to SG are patterns that detect the passage positions in the sub-scanning direction of the light beams. When each of the respective light beams passes the sensor patterns S1 and S2, a position in the sub-scanning direction (hereinafter also simply referred to as a sub-scanning position) of each light beam is detected by each of the sensor patterns SA to SG.

The sensor patterns S1, S2 are formed in a shape elongated in a direction orthogonal to the scanning direction of the light beam such that the light beams (a) to (d) swung by the polygon mirror 35 cross the sensor patterns S1, S2 even if the angles of the Garvano mirrors 33a to 33d are not correctly controlled.

For example, in a case where the light beam (a) scans a position shown by broken arrow Pa, the light beam (a) is controlled by a plurality of comparatively large angle change processings of the Garvano mirror 33a such that it scans a gap between the sensor patterns SB and SC. When the sub-scanning position of the light beam comes near to the center of the sensor patterns SB and SC, the sub-scanning position of the light beam is changed by a minimum amount of adjustment (for example, an amount of 1 μm or less) until it falls within tolerance.

Here, in order to detect the power of the light beam on the photosensitive drum 15, by controlling the sub-scanning position of the light beam such that the light beam passes the sensor pattern SA or SG, for example, as shown by the broken arrow Pa or Pb, it is possible to take in output from the sensor pattern SA or SG as the power of the light beam.

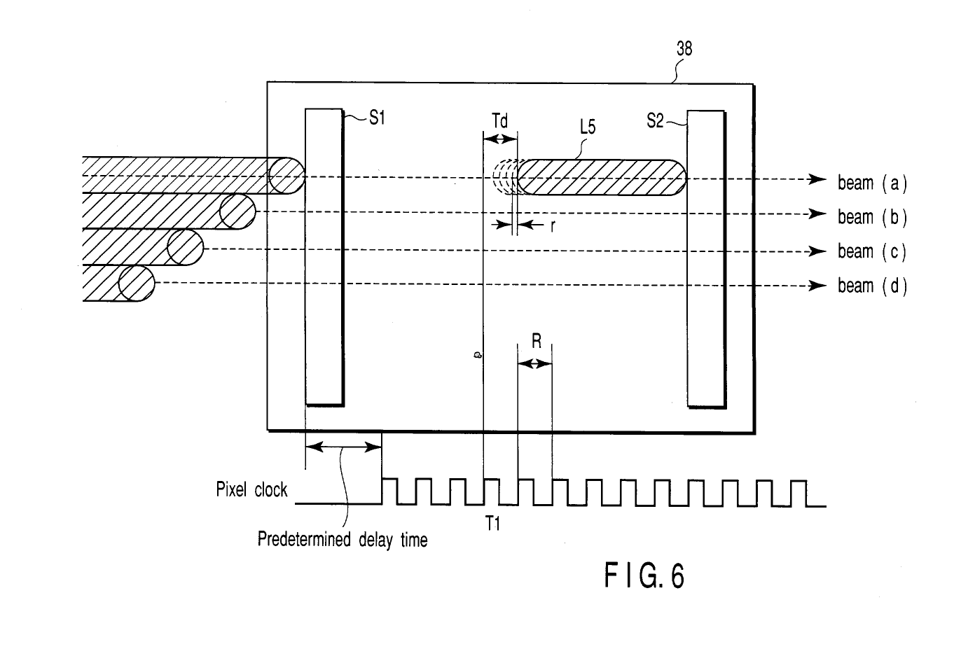

Next, the main control unit 51 executes a routine of control of a position in the main scanning direction of the light beam (ST109). FIG. 6 shows a case where a region between the sensor patterns S1 and S2 on the light beam detecting device 38 is irradiated with the light beam for five pixel clocks. A distance R denotes a distance corresponding to a beam scanning of one period of pixel clock and hence corresponds to one pixel and a reference symbol (r) denotes a minimum amount of adjustment (minimum delay time) in the main scanning direction. The pixel clock is generated after a predetermined delay time from a time when the application of the light beam to the optical pattern S1 is started.

As shown in FIG. 6, for example, a delay time Td from a time T1 when the pixel clock just before an exposure region L5 rises is adjusted, for example, in such a way that the front tip of the exposure region L5 contacts the sensor pattern S2. Performing such control for the light beams (a) to (d) makes the exposure positions in the main scanning direction of the light beams (a) to (d) agree with each other. In this manner, the exposure positions on the photosensitive drum 15 are determined on the basis of the numbers of clocks (three clocks for the light beam (a) in the drawing) and the delay times Td after the predetermined delay time determined for each of the light beams. Thus, the present digital copying machine can adjust the beam position in the main scanning direction by a few fractions of one pixel.

In the present embodiment, the beam position control (ST108, ST109) is performed after the pre-run. In the prior art, the beam position control has been performed during the pre-run. During the pre-run, the heat roller 26a and the photosensitive drum 15 rotate and the developing device 17 operates. Each of the heat roller 26a, the photosensitive drum 15 and the developing device 17 produce comparatively large vibrations. Thus, when the beam position is controlled during the pre-run, this vibrations sometimes elongate a time required for the control to converge and finish. Therefore, in the present embodiment, the light beam position is controlled in a state where the pre-run of the heat roller 26a, the photosensitive drum 15, the developing device 17 and the like is finished and thus the vibrations are hardly produced. This results in shortening a time required for warming up (ST101 to ST109). When the main control unit 51 finishes the warming up, the main control unit 51 resets the timer A and the timer B (ST110) and both of the timer A and the timer B start counting from zero and the apparatus is in a state of waiting a copying command (stand-by state) (ST111).

When the main control unit 51 receives the copying command from the control panel 53 (a copy button is pressed down) in a state of waiting the copying command (ST110), the main control unit 51 makes a copy of the first page (ST112). In the present embodiment, if the copies of all pages are not finished (in a case of NO in step ST113), the main control unit 51 performs a control between sheets as shown in step ST114. The control between sheets means a control of changing a set value of a position in the scanning direction of the light beam by a minimum amount of adjustment in a case where the position in the sub-scanning direction of the light beam is deviated from a desired position. In contrast, here, a control of fully swinging the Garvano mirror (sub-scanning position of the light beam), as shown in the above-described step ST108, is called a full control.

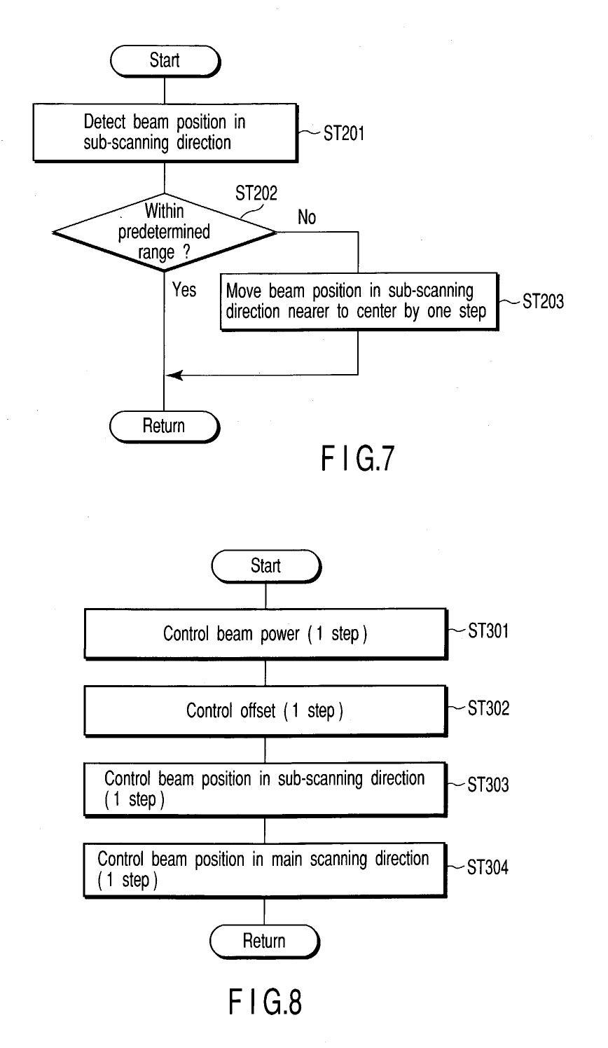

FIG. 7 is a flow chart showing an operation of the control between sheets. The main control unit 51 detects, for example, the position in the sub-scanning direction of the beam (a) (ST201) and in a case where the sub-scanning position detected is not within a predetermined range set at the center of the sensor patterns SB and SC (positional error from the center is larger than a predetermined value), moves the sub-scanning position of the beam nearer to the center by one step (ST203). This one step is a minimum amount of adjustment of the Garvano mirror 33a.

That is, the main control unit 51 decreases or increases by “1” a value set in a D/A converter (not shown) provided in the Garvano mirror driving circuit 39a. Whether the main control unit 51 decreases or increases the value by “1” is determined according to the detected sub-scanning position of the light beam.

The D/A converter changes an analog output according to the changed set value and the Garvano mirror driving circuit 39a amplifies the analog output and supplies it to the Garvano mirror. As a result, the angle of the Garvano mirror is changed by one step, whereby the position in the sub-scanning direction of the beam (a) is changed nearer to the center of the sensor patterns SB and SC. In this manner, an angle change with time passage in the Garvano mirror is corrected.

In the control between sheets in step ST114, the main control unit 51 performs the above-mentioned beam position control in the sub-scanning direction once every sheet for four beams. However, it is also recommended that this control between sheets be performed once every a plurality of copies for four beams or once every sheet for one beam and sequentially for four beams. Further, while the beam position control in the sub-scanning direction is here performed as the control between sheets, as shown in FIG. 8, it is also recommended that the beam power, the offset of the output processing circuit 40 for the beam detecting device, and the position in the main scanning direction of the beam be adjusted by a minimum amount of adjustment, if necessary, as is the case with the control of the position in the sub-scanning direction of the beam. Accordingly, not only the control of the position in the sub-scanning direction of the beam, but also all the controls relating to the beam can be substantially performed in a short time. Moreover, at the time of copying, it is also recommended that all the controls such as steps ST103, ST104, ST108, and ST109 be preformed, for example, once every several tens of copies until the respective errors fall within tolerances. In this manner, also in a case of continuously making a large number of copies, it is possible to always form an image in an optimum state.

As described above, in this embodiment, when the main control unit 51 receives a copying command, it immediately performs the copying operation. In the case of a conventional apparatus, when the apparatus receives the copying command, it performs all the controls or corrections of steps ST103, ST104, ST108, and ST109 until the respective errors fall within tolerances and then performs the copying operation and further sometimes performs all the controls relating to the beam of the steps ST103, ST104, ST108, and ST109 for each sheet. In the case of this embodiment, in the standby state as shown in the step ST115, the beam scanning position and the like are already adjusted, as will be described later. Thus, at the time of copying, all the controls or corrections of the steps ST103, ST104, ST108, and ST109 need not to be performed but, for example, only the control of position in the sub-scanning direction of the beam, which is easily changed by environmental conditions such as temperature and moisture, is adjusted by a minimum amount of adjustment if necessary. As a result, this can shorten a total copying time.

In a case where the content of the timer A is larger than a value of Ta (for example, a value corresponding to several seconds) in a state of waiting the copying command (in a case where it is determined that an answer in step ST115 is YES), the main control unit 51 performs the control between sheets as shown in step ST116. This control between sheets is the same control as step ST114. That is, the main control unit 51 detects the position in the sub-scanning direction of the beam once every several seconds and in a case where the position in the sub-scanning direction of the beam is deviated from a desired position, changes the set value of the position in the sub-scanning direction of the beam by a minimum amount of adjustment. Then, the main control unit 51 resets the timer A and the timer A starts counting again from zero and advances the control to step ST118.

In a case where the content of the timer B is larger than a value of Tb (for example, a value corresponding to several minutes) in a state of waiting the copying command (in a case where it is determined that an answer in step ST118 is YES), the main control unit 51 performs the beam power control, the offset correction, the beam position control in the sub-scanning direction and the beam position control in the main scanning direction as shown in steps ST119 to ST122. These controls and correction are the same as in steps ST103, ST104, ST108, and ST109. That is, the main control unit 51 performs the respective controls and correction until the respective values detected fall within desired ranges. For example, in the case of the beam position control in the sub-scanning direction, the main control unit 51 fully swings the Garvano mirror and then continues performing the beam position control in the sub-scanning direction while gradually changing a set value for the Garvano mirror driving circuit 39 until the sub-scanning position of the beam falls within a desired range.

When the main control unit 51 finishes the beam position control in the main scanning direction in step ST122, the main control unit 51 advances the control to step ST110 where it resets the timers A and B and then repeats steps ST115 to ST122 until it receives the copying command.

As described above, the multi-beam control includes various controls. When the power is turned on, all the controls are performed, as shown in the steps ST103, ST104, ST108, and ST109, until the respective errors converge within tolerances, but at the other steps, the controls according to the state of the apparatus are performed. For example, in the standby state, the control between sheets is performed every several seconds as shown in steps ST115 to ST117, and all the controls relating to the beam are performed every several minutes as shown in steps ST119 to ST122. Further, in the copying operation, only the control between sheets is performed as shown in step ST114.

What is claimed is:

1. A method of controlling an light beam scanning position in a multi-beam image forming apparatus in which a photosensitive drum is simultaneously scanned with and exposed to a plurality of light beams to form an electrostatic latent image on the photosensitive drum, the method comprising the steps of:
bringing the apparatus into a standby state by initializing respective units in the apparatus when power of the apparatus is turned on, and performing a control of a beam scanning position by which positional errors in a main scanning direction and in a sub-scanning direction of the light beams are converged to respective predetermined values or less; and
performing a simplified control of the beam scanning position every predetermined time in the standby state.

2. The method according to claim 1, wherein the simplified control of the beam scanning position includes a control of changing a beam position in the sub-scanning direction by a minimum amount of adjustment, if necessary.

3. The method according to claim 1, wherein the simplified control of the beam scanning position includes a control of changing a beam position in the main scanning direction and in the sub-scanning direction by a minimum amount of adjustment, respectively, if necessary.

4. A method of controlling an light beam scanning position in a multi-beam image forming apparatus in which a photosensitive drum is simultaneously scanned with and exposed to a plurality of light beams to form an electrostatic latent image on the photosensitive drum, the method comprising the steps of:
bringing the apparatus into a standby state by initializing respective units in the apparatus when power of the apparatus is turned on, and performing a control of a beam scanning position by which positional errors in a main scanning direction and in a sub-scanning direction of the light beams are converged to respective predetermined values or less; and
performing a simplified control of the beam scanning position every a predetermined number of copies during a copying operation.

5. The method according to claim 4, wherein the simplified control of the beam scanning position includes a control of changing a beam position in the sub-scanning direction by a minimum amount of adjustment, if necessary.

6. The method according to claim 4, wherein the predetermined number of copies is one.

7. The method according to claim 4, wherein the simplified control of the beam scanning position includes a control of changing a beam position in the main scanning direction and in the sub-scanning direction by a minimum amount of adjustment, respectively, if necessary.

8. A multi-beam image forming apparatus in which a photosensitive drum is simultaneously scanned with and exposed to a plurality of light beams to form an electrostatic latent image on the photosensitive drum, the apparatus comprising:
a standby state setting section which brings the apparatus into a standby state by initializing respective units in the apparatus when power of the apparatus is turned on, and performing a control of a beam scanning position by which positional errors in a main scanning direction and in a sub-scanning direction of the light beams are converged to respective predetermined values or less; and
a control section which performs a simplified control of the beam scanning position every predetermined time in the standby state.

9. The apparatus according to claim 8, wherein the simplified control of the beam scanning position includes a control of changing a beam position in the sub-scanning direction by a minimum amount of adjustment, if necessary.

10. The apparatus according to claim 8, wherein the simplified control of the beam scanning position includes a control of changing a beam position in the main scanning direction and in the sub-scanning direction by a minimum amount of adjustment, respectively, if necessary.

11. The apparatus according to claim 8, further comprising a second control section which performs a simplified control of the beam scanning position every a predetermined number of copies during a copying operation.

12. The apparatus according to claim 11, wherein the simplified control of the beam scanning position includes a control of changing a beam position in the sub-scanning direction by a minimum amount of adjustment, if necessary.
